(19) United States
(12) Patent Application Publication
(10) Pub. No.: US 2004/0103287 A1
(43) Pub. Date: May 27, 2004

(54) Electronic device with time dependent access codes and apparatus for generating those codes

(76) Inventors: Robert Matthew Newby, Auckland (NZ); Christopher Murray Anthony Hamling, Auckland (NZ); John William Nelson Hodgson, Auckland (NZ); Kenneth Edwin Thomas, Auckland (NZ)

Correspondence Address: BELL, BOYD & LLOYD, LLC, PO BOX 1135, CHICAGO, IL, 60690-1135, US

(21) Appl. No.: 10/362,987

(22) PCT Filed: Sep. 3, 2001
(86) PCT No.: PCT/NZ01/00181

(30) Foreign Application Priority Data
Sep. 1, 2000 (NZ) 506673

(51) Int. Cl. H04L 9/00

(52) U.S. Cl. 713/184

(57) ABSTRACT

An electronic system is provided including at least one electronic device and at least one authorisation code generation apparatus including input means (F) for facilitating the input of time information (B) defining one or more time periods during which the electronic device may be actuated through use of an authorisation code (E), a first processing means (G) to receive as an input the time information (B) and generate the authorisation code (E) dependent on the time information (B) and transmission means (H) to directly or indirectly communicate the authorisation code generated by the first processing means (D) to one or more of the electronic devices. The electronic device or devices include receiving means (J) for receiving an authorisation code (E) generated by the code generation apparatus, time measuring means for indicating a time value (K) related to the time of receipt of an authorisation code (E) by the receiving means (J), second processing means (M) to compute one or more validation codes (N) dependent upon at least the time value (K) and compare the one or more validation codes (N) to the authorisation code (E) and means to actuate the electronic device if the second processing means (M) determines that at least one of the one or more validation codes (N) match the authorisation code (E) or has a predetermined relationship with the authorisation code (E). The code generation apparatus and electronic device are also claimed per se.

### BACKGROUND OF THE INVENTION

This invention relates to an electronic device having time dependent access and a code generation apparatus for generating access codes for the electronic device and in particular but not exclusively to an electronic lock and a code generation apparatus therefor.

Electronically controlled locks are widely used to secure property and premises. These locks may receive an entry code, and from the code entered may determine if the lock should be opened. In a large number of instances staff or security agents employed by the owner of the secured property or premises may need access codes for these locks to perform their daily duties. However, it is also important to restrict the access to the locks outside of these persons' normal working hours or the time periods in which they are supposed to have access to the locks.

In some instances security agencies use two person teams, where each team member has a portion only of the authorisation code needed to open the lock. This does not entirely solve the above problem as both members of the team may still collude together to obtain unauthorised access to the lock outside of their normal working hours. Furthermore, employing two people to complete a job that can be performed by one person also significantly increases the cost of using the security agents involved.

One attempt to address these problems is disclosed in the specification of U.S. Pat. No. 5,488,660. This document describes a lock that is adapted to receive one time use codes generated both within the lock and at a remote base of the security agency. The initial one time use code can be generated at the remote base and supplied to security agents. This code may be calculated through the use of several consonant values and a variable defined as a “seal count”, which is the number of times that the lock in question has been opened using the authorisation codes generated. Once the code is generated the security agent may then travel to the lock and enter the one time code to gain access to the lock.

If there are any discrepancies between the seal count kept at the remote base and the actual seal count recorded by the lock, any codes generated by the remote base will not work to open the lock. Furthermore, the above system does not place any restrictions on the times in which a particular lock can be opened. As long as a person is in possession of the one time code generated and the lock has not been opened since the code was generated, they may gain access to the lock at any time.

Electronic combination locks with changeable entry codes and lockout functions already exist, such as the invention described in the specification of U.S. Pat. No. 5,021,776. In such a system the entry codes allow access at any time until the lock is reprogrammed at the lock site to remove or change that specific code or the code is temporarily locked out by the master code.

Problems with such systems arise due to the master user having to manually lock out a user or permanently remove their access code at the lock site rather than remotely. Such practical inconvenience greatly increases the likelihood of a security breach such as a code reprogramming or code lock-out being delayed or neglected. Should the master code in such a system be learned by an unauthorised person that person would have unfettered access and could block access by legitimate users.

Time specific components in access codes have been utilised in the field of software access protection, such as the system detailed in the specification of U.S. Pat. No. 4,599,489. In this invention the user is issued with a device analogous to a key that executes a prescribed algorithm over a unique number loaded into the card at the time of manufacture and a time component subject to real world time to generate a non-predictable unique code. This system was envisaged to protect access to software not locks and has disadvantages in an application protecting units of value such as electronic lock or safe systems. Firstly, the code-generating device is carried by the user on their person. A problem with such devices is that should one come into the hands of an unauthorised person they could breach the protected system's integrity. Secondly, the above system utilises the time component to systematically alter the access code on a daily basis, (one count recorded by the pulse generator daily). It does nothing to control the specific time and period when the user can obtain access, an important requirement, for instance, in controlling the hours staff can access the store vault to prevent inside-knowledge theft.

Another application of time varying codes is the locking system described in the specification of U.S. Pat. No. 5,673,034, which relays time varying codes generated by a central code generating apparatus through a linking apparatus to access granting devices that grant or deny access to a remote terminal depending on whether the code segment matches the currently valid access codes. The time varying codes are also transmitted to the access granting device at predetermined intervals. Such a system is not as secure as one that does not rely on mobile access controlling devices to provide limited control over the times when a person may obtain access to a remote terminal. Such a device also requires a communications link between the access granting device and the central code generating apparatus.

The system detailed in the specification of U.S. Pat. No. 5,023,908 includes an apparatus for personal identification and verification that generates a time-dependent non-predictable code, which is combined with part of the individual user's pin, unique to that individual. This code is compared to a code separately generated by a central verification computer. The main purpose of such a system is to control access to the system by protecting the integrity of the pin from electronic eavesdropping.

Having a plurality of unsecured code generating devices may constitute an added security risk. Once again, whilst securing the users identity, controlling when they get access is not controlled. An improved electronic combination lock that solved any or all of the above problems would be of advantage. Specifically a combination lock that could restrict the times at which its access codes could be used and which could generate access codes using simple and easily obtained variables would be of advantage. Furthermore, an improved electronic lock which could be opened using authorisation codes generated at a remote location and which did not need a communications link with the remote location involved would be of advantage.

Thus, it is an object of the present invention to provide an electronic lock that overcomes or alleviates problems with electronic locks at present by providing functionality to permit time controlled access to authorised persons and which is secure and uses readily available input variables.

A further or alternative object of the present invention is to provide the public with a useful alternative.

Further objects of the present invention may become apparent from the following description.

Any discussion of the prior art throughout the specification should in no way be considered as an admission that such prior art is widely known or forms part of common general knowledge in the field.

### SUMMARY OF THE INVENTION

According to one aspect of the invention, there is provided a code generation apparatus for generating at least one authorisation code for an electronic device, the apparatus including:

input means for facilitating the input of time information defining one or more time periods during which the electronic device may be actuated through use of the authorisation code;

processing means to receive as an input the time information and generate an authorisation code dependent on the time information; and

transmission means to directly or indirectly communicate the authorisation code generated by the processing means to the electronic device.

Preferably, the or each time period may be defined by a start time not being substantially the time of generation of the authorisation code.

Preferably, the or each time period may further be defined by an end time.

Preferably, the code generation apparatus may generate an authorisation code from incomplete time information, wherein the incomplete time period defines an extended time period or multiple time periods.

Preferably, the code generation apparatus may automatically remove time information to create the incomplete time information.

Preferably, the apparatus may also include identity information receiving means for receiving identity information identifying one or more users of the electronic device, wherein in use, the processing means receives the identity information and computes the authorisation code dependent on the identity information and the time information.

Preferably, the processing means may generate an authorisation code from incomplete identity information, wherein the incomplete identity information defines a plurality of users.

Preferably, the apparatus may also include device information receiving means for receiving device information defining one or more electronic devices, wherein in use, the processing means receives the device information and computes the authorisation code dependent on the device information and the time information.

Preferably, the code generation apparatus may generate an authorisation code from incomplete device information, wherein the incomplete device information defines a plurality of electronic devices.

Preferably, the processing means may compute the authorisation code dependent on the time information, the identity information and the device information.

According to another aspect of the invention, there is provided an electronic device including:

receiving means for receiving an authorisation code;

time measuring means for indicating a time value related to the time of receipt of an authorisation code by the receiving means;

processing means to compute one or more validation codes dependent upon at least the time value and compare the one or more validation codes to the authorisation code; and

means to actuate the electronic device if the processing means determines that at least one of the one or more validation codes match the authorisation code or has a predetermined relationship with the authorisation code.

Preferably, the time value may define an extended time period or multiple time periods.

Preferably, the code generation apparatus may automatically remove time information received from the time measuring means to create the time value.

Preferably, the electronic device may also include identity information receiving means for receiving identity information identifying one or more users of the electronic device, wherein in use, the processing means receives the identity information and computes the validation code dependent on the identity information and the time value.

Preferably, the electronic device may compute a validation code from incomplete identity information, wherein the incomplete identity information defines a plurality of users.

Preferably, the electronic device may remove identity information from information received by the identity information receiving means to create the incomplete identity information.

Preferably, the electronic device may determine from the incomplete identity information an identity code identifying each user defined by the incomplete identity information and compute a validation code for each identity code, wherein the electronic device is actuated if any one of the validation codes match the authorisation code or is a predetermined transformation of the authorisation code.

Preferably, the electronic device may include a predetermined device code readable by the processing means, wherein in use, the processing means computes the validation code dependent on the predetermined device code and the time value.

Preferably, the electronic device may include a plurality of device codes, wherein the processing means computes a validation code for each device code and wherein the electronic device is actuated if any one of the validation codes match the authorisation code or is a predetermined transformation of the authorisation code.

Preferably, the processing means may compute the or each validation code dependent on the time value, identity information and device information.

Preferably, the authorisation code may be generated by a code generation apparatus described herein above and the processing means of the electronic device may be programmed to compute a validation code that matches the authorisation code or has a predetermined relationship with the authorisation code when the time value is within a time period defined by the time information.

Preferably, the authorisation code may be generated by a code generation apparatus as described herein above and the processing means of the electronic device may be programmed to compute a validation code that matches the authorisation code or has a predetermined relationship with the authorisation code when the identity information received by the electronic device defines at least one user defined by the identity information received by the code generation apparatus.

Preferably, the authorisation code may be generated by a code generation apparatus described herein above and the processing means of the electronic device may be programmed to compute a validation code that matches the authorisation code or has a predetermined relationship with the authorisation code when the device information of the electronic device is the, or one of the devices defined by the device information received by the code generation apparatus.

Preferably, the authorisation code may be generated by the code generation apparatus of claim 10 and the processing means of the electronic device is programmed to compute a validation code that matches the authorisation code or has a predetermined relationship with the authorisation code when the time value is within a time period defined by the time information and the identity information received by the electronic device defines at least one user defined by the identity information received by the code generation apparatus and the device information of the electronic device is the, or one of the devices defined by the device information received by the code generation apparatus.

According to another aspect of the invention, there is provided an electronic system including at least one electronic device and at least one code generation apparatus for generating at least one authorisation code, the code generation apparatus including:

input means for facilitating the input of time information defining one or more time periods during which the electronic device may be actuated through use of the authorisation code;

first processing means to receive as an input the time information and generate an authorisation code dependent on the time information; and

transmission means to directly or indirectly communicate the authorisation code generated by the first processing means to one or more of the electronic devices;

wherein the or each electronic device includes:

receiving means for receiving an authorisation code generated by the code generation apparatus;

time measuring means for indicating a time value related to the time of receipt of an authorisation code by the receiving means;

second processing means to compute one or more validation codes dependent upon at least the time value and compare the one or more validation codes to the authorisation code; and

means to actuate the electronic device if the second processing means determines that at least one of the one or more validation codes match the authorisation code or has a predetermined relationship with the authorisation code.

Preferably, the or each time period may be defined by a start time not being substantially the time of generation of the authorisation code.

Preferably, the or each time period may further be defined by an end time.

Preferably, the second processing means may be adapted to compute a validation code that matches the authorisation code or has the predetermined relationship with the authorisation code when the time value is within a time period defined by the time information and not otherwise.

Preferably, both the code generation apparatus and electronic device may include identity information receiving means for receiving identity information identifying one or more users, wherein the first and second processing means receives the identity information and computes the authorisation code and validation code respectively dependent on the identity information and the time information and wherein the second processing means computes a validation code that matches the authorisation code or has the predetermined relationship with the authorisation code when the identity information received by the electronic device defines at least one user defined by the identity information received the code generation apparatus and not otherwise.

Preferably, the code generation apparatus may include device information receiving means for receiving device information defining one or more electronic devices and the or each electronic device includes at least one device code, wherein the first processing means computes the authorisation code dependent on the device information and the time information and the second processing means computes a validation code dependent for the or each device code and is adapted to compute a validation code that matches the authorisation code or has the predetermined relationship with the authorisation code when the device information defines the, or one of the device codes.

Preferably, the electronic device may be an electronic lock.

Further aspects of the present invention, which should be considered in all its novel aspects, may become apparent from the following description, given by way of example only and with reference to the accompanying drawings.

### BRIEF DESCRIPTION OF THE FIGURES

FIGS. 1 and 2: show block diagrams of the elements and information flows within a code generation apparatus in accordance with one embodiment of the present invention; and

FIGS. 3 to 5: show block diagrams of the elements and information flows within an electronic device in accordance with an embodiment of the present invention.

### DETAILED DESCRIPTION OF THE INVENTION

The present invention relates to the provision of an electronic device with time dependent access codes. The device may be used for controlling access to objects, spaces, information or other items. An authorisation code generation apparatus is also provided to generate authorisation codes that are used by the electronic lock in order to determine if it should grant access to the above items. The authorisation codes are valid for a specific period of time only.

Although the following description is given with specific reference to an electronic lock, those skilled in the art will appreciate that the present invention may have application to access to any device.

A user of the present invention may be any person wishing to actuate an electronic lock (or other device) within a specific time period. Users of the present invention may include security agents contracted to perform security services for property secured by the lock. However, the present invention may have application elsewhere.

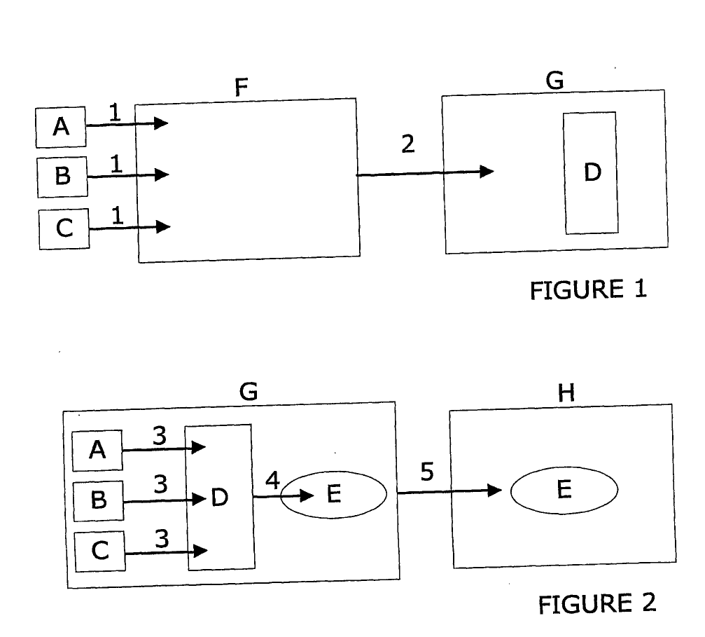

FIGS. 1 and 2 show block schematic diagrams of the elements and information flow present within a code generation apparatus in accordance with a preferred embodiment of the present invention. A code generation apparatus that includes a code entry means F, processing means G and a transmission means H is provided. The apparatus is configured to generate an authorisation code E, which may be used to actuate an electronic lock.

Referring to FIG. 1, the code entry means F may be provided to receive user identity codes A for identifying users, a time variable B for defining when an authorisation code may be used to actuate an electronic lock and an encryption key C for identifying the lock or locks that the authorisation code may actuate. The step of receiving this information is indicated by arrows 1. These input variables are passed to the processing means G, as indicated by arrow 2.

The code entry means F may in preferred embodiments be adapted to receive alphanumeric digits. Computer keyboards or keypads may be used in such instances to provide a suitable code entry means. Alternatively, in other embodiments a code entry means may be a magnetic strip code reader, voice recognition system, or optical bar code readers, which can be used to supply codes to either a lock or a code generation apparatus. Although for the purposes of clarity, reference throughout the remainder of this specification will be made to the preferred embodiment of a standard computer keyboard as the code entry means. Those skilled in the art will recognise that other means of information input may be used to enter the required information.

The identity code A may be unique to a person or group of people who require access to a lock to be opened by the generated authorisation code E. The identity code A is therefore used to control who can access particular locks. Thus, the identity code A may be a password or the like known only to the user or users involved. The identity code A may alternatively consist of a public portion and a private portion, where the public portion is used to retrieve the private portion from an electrical information storage device associated with the code generating apparatus. In further alternative embodiments, the identity code A may be a random code, a chosen code or the code generation apparatus may use the entered public portion of the user identity code to retrieve the private portion of the same code stored within its own memory. If it is not required to control who can access particular locks, the identity code A may be omitted.

Incomplete information may be provided to the code generation apparatus to define a number of identity codes A. If the identity code information is so entered, a single authorisation code E may be used by a number of users. Alternatively, the code generation apparatus may automatically mask some part of an entered identity code.

If incomplete information is used, the electronic lock should be aware of at least the possibility that the authorisation code E has been generated from incomplete identity code information. The electronic lock may always treat the authorisation codes as if they were formed from incomplete information, or the authorisation code E or information accompanying the authorisation code E may contain information informing the lock that incomplete information has been used. Other methods of notifying the lock that incomplete information has been used may also be used if required.

The time variable B may be any specific time, any representation of a specific time or any predetermined period past, present or in the future when the authorisation code E will be valid. The time period may commence at a time other than the time of generation of the authorisation code E and may also be defined by an end period after which the authorisation code ceases to actuate the lock. The time period may be any length provided that a corresponding length of time is used in the electronic lock.

The encryption key C may be specific to each lock where it is required that the authorisation code for more than one lock be different given the other inputs are the same. Where it is required that a single authorisation code grant access to a plurality of locks, the encryption key C may be common to a set of locks. For example, in the same way that by entering incomplete identity code, a plurality of identity codes are defined, incomplete encryption key information may be used to define a plurality of locks.

Those skilled in the art will realise that the use of the encryption key C is a specific example, wherein in practice any input value may be used by the algorithm D within the processing means G to identify one or more locks and generate the authorisation code. The encryption key C may be omitted if it is not required.

The identity code A, time variable B and/or encryption key C may have representative values that may be entered into the code generation apparatus instead of the actual values. The code generation apparatus may then convert these representative values to actual values by a suitable database lookup. Those skilled in the art will realise that any form of cross-reference table or the like may be used. Similarly, representative values may be entered into the electronic lock. Furthermore, additional values, identifiers or similar may be used as inputs for generating the authorisation code as required.

Referring now to FIG. 2, an algorithm, represented by D, which when implemented by the processing means G uses inputs A, B and C as indicated by the arrows 3 to create, as an output, the authorisation code E, as indicated by arrow 4. The algorithm D is preferably one that does not allow any of the inputs to be determined from the output. For example, to generate a authorisation code E of X number of digits, the Blowfish encryption algorithm with an encryption key C of 128 bits may be utilised. The user identity code A and the time variable B are copied into a processing buffer of at least X digits, which is then encrypted. The authorisation code E is obtained by extracting X digits from the resulting buffer. Those skilled in the art will realise that the blowfish encryption algorithm may be replaced by any function suitable for generating authorisation codes. Although the description herein is given with specific reference to the Blowfish encryption algorithm and other mathematical processes and/or algorithms, those skilled in the art will appreciate that the present invention may use other processes to the same or similar effect.

The algorithm D may be specific to each lock where it is desired that the authorisation code for more than one lock be different given all the inputs are the same. Where it is desired that a single authorisation code grant access to a plurality of locks the algorithm D may be common to a set of locks. Furthermore a single lock may utilise more than one algorithm D to allow it to be common to more than one set of locks. The code generation apparatus G may use different algorithms D, to generate different authorisation codes E for the same lock.

Those skilled in the art will realise that most practical applications will use the same algorithm D and vary the encryption key C.

The time variable B may be processed prior to being copied into the processing buffer of processing means G by way of rounding the time variable B to a predetermined granularity or ignoring the minutes, hours or days or whatever the user of the system specifies. This allows an authorisation code to be generated that will be valid for a fixed period of time, with a known start time and end time.

In another embodiment, multiple time periods can be accepted by taking the time variable B prior to being copied into the processing buffer of processing means G and ignoring, for example, the day, month and or year information. This can be accomplished using a mathematical modulo function. This would result in an authorisation code being valid for the same time every day, month or year. Alternatively, a user may enter information that is incomplete to fully define a single time period to achieve the same result. Those skilled in the art will realise ignoring other parts of the time variable B will result in the authorisation code being valid for different periodicity's.

Additionally, the processing means G may use information entered at the code entry means F to derive the values for input parameters to algorithm D to form an authorisation code E.

The processing means G may be any type of processor that can be loaded with software or algorithms that can calculate authorisation codes, ranging from a small low power microprocessor through to a processor used in personal computers or workstations. Reference throughout this specification will also be made to a processing means included in either the electronic lock or code generation apparatus as being a microprocessor. However, those skilled in the art will appreciate that a wide range of processing means may be used in conjunction with the present invention and reference to the above only throughout this specification should in no way be seen as limiting.

The code generation apparatus includes a transmission means H, which receives as input the calculated authorisation code E from the processing means G as shown by arrow 5. The transmission means H is adapted to communicate directly, or indirectly such as with user interaction, the calculated authorisation code E to the electronic lock. This communication may or may not include a person. In the event of a person being included in the transmission chain the output may take the form of a visual display, a printed output or an audio output. The authorisation code E may also be transmitted onto some electronic storage means carried by the person. Those skilled in the art should appreciate that transmission of the authorisation code E need not be made directly to the user of the lock, but could be made to any number of intermediaries first, including people, depending on the particular utilisation of the invention. Those skilled in the art should also appreciate that the transmission of authorisation code E may be made directly to the electronic lock.

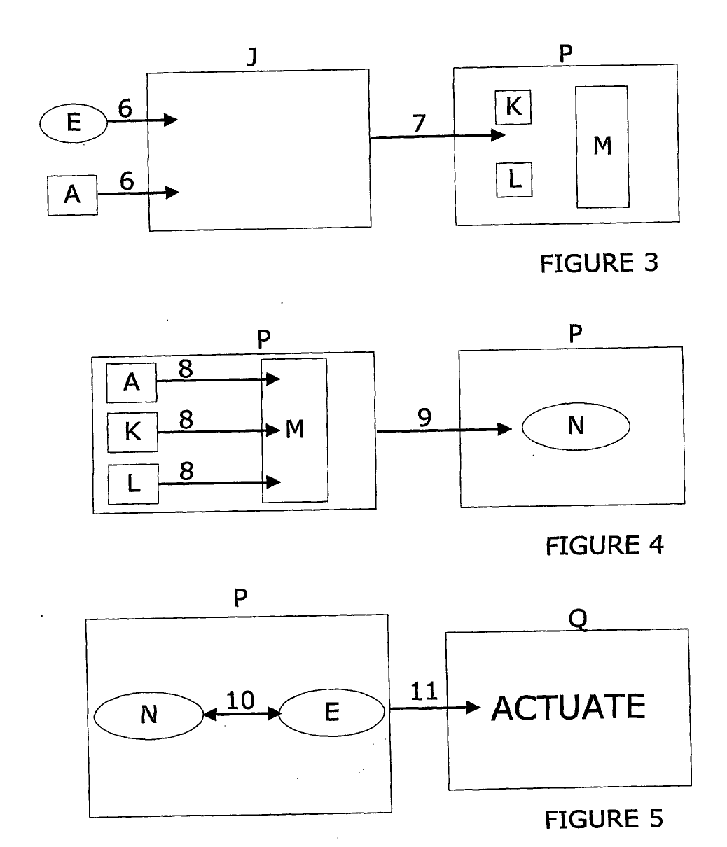

Referring now to FIGS. 3 to 5, a block diagram representation of an electronic lock is shown. FIGS. 3-5 also show the flows of information through the lock when unlocking it by utilising the process of the present invention.

The lock includes a code entry means J, a time recorder K, an encryption key L, which is unique to the lock or to the set of locks to be controlled by the same authorisation code, a processing means P and an actuation means Q.

The code entry means J may be a keypad, into which an identity code A and/or a representative portion thereof and an authorisation code E may be entered as indicated by arrows 6. Computer keyboards or keypads may be used in such instances to provide a suitable code entry means. Alternatively, in other embodiments a code entry means J may be a magnetic strip code reader, voice recognition system, or optical bar code readers, which can be used to supply codes. Although for the purposes of clarity, reference throughout the remainder of this specification will be made to the preferred embodiment of a keypad as the code entry means J. Those skilled in the art will recognise that other means of information input may be used to enter the required information.

In an alternative embodiment, the code entry means J may be used solely for the entry of an authorisation code, not for the identity code A. In this embodiment, the identity code A may be absent from the determination of whether the authorisation code is valid, resulting in any user being able to access the lock once they have a suitable authorisation code. The identity code A may alternatively be stored within the lock, thereby fixing who can actuate the lock, requiring reprogramming of the lock to allow access to different or additional users. However, by requiring the identity code A to be entered at the lock, increased flexibility is obtained over changing the valid users and the requirement for reprogramming of the lock locally or remotely each time a user is changed is avoided.

Code entry means J passes the authorisation code E and identity code A to the processing means P as indicated by arrow 7. The processing means P may be any type of processor that can be loaded with software or algorithms that can validate authorisation codes, ranging from a small low power microprocessor through to a processor used in personal computers or workstations. However, those skilled in the art will appreciate that a wide range of processing means may be used in conjunction with the present invention and reference to the above only throughout this specification should in no way be seen as limiting.

In a preferred embodiment, the time recorder K is any suitable time keeping device, such as a real time clock chip, that can be implemented within or incorporated into the processing means P. Those skilled in the art will appreciate that the processing means P may also obtain its time input from code entry means J.

The encryption key L may be equivalent to encryption key C, or may be equivalent to the result of a predetermined transformation of the encryption key C performed by the processing means P or other device within the information cycle. The encryption key L may be stored within the processing means P, be hardware defined or stored in any other form readable by the processing means P.

A single lock may utilise more than one encryption key to allow it to be common to more than one set of locks. For example, depending on inputs such as identity code A, multiple encryption keys may be derived from a single encryption key by masking parts of that single key. Algorithms or hardware suitable for masking parts of keys are well known and thus will not be described herein. Thus, the lock may compute a number of validation codes N, wherein if any one matches the authorisation code E, the lock is actuated.

If this function is known at the time of generation of the authorisation code E by the code generation apparatus, then there may be no need to enter incomplete information defining the encryption key C. However, if incomplete information is entered to generate the authorisation code E, then the lock may compute a single validation code N by removing the additional information from the identity code that it receives.

Referring to FIG. 4, an algorithm M is provided by the processing means P that takes as input parameters the recorded time supplied by K, identity code A and encryption key L as indicated by arrows 8. The encryption key L may be the same as the encryption key C and the algorithm M may be the same as the algorithm D. The encryption keys L and C and algorithms D and M are not necessarily the same. The generation of the validation code N of the algorithm M is indicated by arrow 9. The algorithm M is preferably one that does not allow any of the inputs to be determined from the output. For example, to generate a validation code N of X number of digits, the Blowfish encryption algorithm with an encryption key L of 128 bits may be utilised. The user identity code A and the time variable K are copied into a processing buffer of at least X digits, which is then encrypted. The validation code N is obtained by extracting X digits from the resulting buffer. Those skilled in the art will realise that the blowfish encryption algorithm may be replaced by any function suitable for generating validation codes.

Referring to FIG. 5, in the embodiment that the encryption keys L and C and algorithms D and M are the same, if the validation code N and the authorisation code E are the same, the lock is to be actuated. Those skilled in the art will realise that an exact match may not be required in all circumstances and a validation function that can predictably compare a non-exact authorisation code and validation code may be suitable. Where the encryption keys L and C and algorithms D and M are not the same, then the lock is actuated if the validation code N and authorisation code E are related to each other in predetermined way. For example, the lock may be actuated if the validation code N and authorisation code E are a predetermined transformation of each other or if the validation code N is a specific value or falls within a set of values, which are determined by the authorisation code or a part thereof.

For instance in one embodiment the last digit of the authorisation code E may be different to the last digit of the validation code N. In this case the authorisation code E would be considered valid for the purpose of actuating the lock; however the authorisation code entered may trigger an alarm event to indicate that the person entering the code is doing so under duress.

The electronic lock may mask some part of the identity code A if it is aware that the authorisation code was generated by masking the identity code A. This may be required to obtain matching validation code N and authorisation code E. Alternatively, the electronic lock may compute a number of validation codes N for each of a number of identity codes based on the entered identity code A, but with a predetermined part varying through all or selected possibilities. If the electronic lock performs this, then the requirement to mask the identity code for generation of the authorisation code N may be avoided.

The time variable K may be processed prior to being copied into the processing buffer of processing means P by way of rounding the time variable K to a predetermined granularity or ignoring the minutes, hours or days or whatever the user of the system chooses. This allows a validation code to be generated that will be same for a fixed period of time, with a known start time and end time. To maintain consistency, the code generation apparatus will use the same rounding method.

In another embodiment, multiple time periods can be accepted by taking the time variable K prior to being copied into the processing buffer of processing means P and ignoring the days, months and years information. This can be accomplished using a mathematical modulo function. This would result in the same validation code N being generated for the same time every day, month or year. The authorisation code E may be generated by the code generation apparatus using the same modulo function to result in incomplete time information or the information may be manually entered.

Alternatively, if a more completely defined time period was used to generate the authorisation code E, the lock may compute a number of validation codes N and determine if any one matches the authorisation code in the same way as for the identity code A. For instance, it may be determined that the lock may be actuated any time within periods of three hours. Therefore, the time variable K may have a granularity of three hours. However, the code generation apparatus may have a granularity of one hour and thus the time variable K incompletely defines the passage of time. Thus, for an authorisation code that is to be valid for three hours with a new authorisation code being calculated every hour, three validation codes would be calculated. One for the time value, one for a time value one hour earlier and one for a time value two hours earlier. In this configuration at any moment there would be three valid authorisation codes. Those skilled in the art will realise ignoring other parts of the time variable K will result in the same validation code being generated for different periodicity's.

If the lock is to be actuated, a control signal is sent to the actuation means Q from processing means P as indicated by arrow 11. The actuation means may be any type of electrically controlled device that can perform the physical actions required to disengage the locking components of the electronic lock. Those skilled in the art should appreciate that any number of a range of electronic motors, solenoids or other mechanically operated components may be used to implement an actuation means and therefore have not been discussed in this specification.

An example application of the invention may be for controlling access to remote buildings. An authorisation code may be generated for a door lock, which would allow a person access to a building for a specified period of time only. This eliminates the problems associated with the issuing, handling, returning and controlling of keys. No fixed or regular communication between the code generation apparatus and the electronic device is required.

Where in the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the appended claims.

1. A code generation apparatus for generating at least one authorisation code for an electronic device, the apparatus including:
input means for facilitating the input of time information defining one or more time periods during which the electronic device may be actuated through use of the authorisation code;
processing means to receive as an input the time information and generate an authorisation code dependent on the time information; and
transmission means to directly or indirectly communicate the authorisation code generated by the processing means to the electronic device.

2. The code generation apparatus of claim 1, wherein the or each time period is defined by a start time not being substantially the time of generation of the authorisation code.

3. The code generation apparatus of claim 2, wherein the or each time period is further be defined by an end time.

4. The code generation apparatus of any one of claims 1 to 3, wherein the code generation apparatus generates an authorisation code from incomplete time information, wherein the incomplete time period defines an extended time period or multiple time periods.

5. The code generation apparatus of claim 4, wherein the code generation apparatus automatically removes time information to create the incomplete time information.

6. The code generation apparatus of any one of the preceding claims, wherein the apparatus also includes identity information receiving means for receiving identity information identifying one or more users of the electronic device, wherein in use, the processing means receives the identity information and computes the authorisation code dependent on the identity information and the time information.

7. The code generation apparatus of claim 6, wherein the processing means generates an authorisation code from incomplete identity information, wherein the incomplete identity information defines a plurality of users.

8. The code generation apparatus of any one of the preceding claims, wherein the apparatus also includes device information receiving means for receiving device information defining one or more electronic devices, wherein in use, the processing means receives the device information and computes the authorisation code dependent on the device information and the time information.

9. The code generation apparatus of claim 8, wherein the code generation apparatus generates an authorisation code from incomplete device information and wherein the incomplete device information defines a plurality of electronic devices.

10. The code generation apparatus of claim 8 or claim 9 when dependent on either one of claims 6 or 7, wherein the processing means computes the authorisation code dependent on the time information, the identity information and the device information.

11. An electronic device including:
receiving means for receiving an authorisation code;
time measuring means for indicating a time value related to the time of receipt of an authorisation code by the receiving means;
processing means to compute one or more validation codes dependent upon at least the time value and compare the one or more validation codes to the authorisation code; and
means to actuate the electronic device if the processing means determines that at least one of the one or more validation codes match the authorisation code or has a predetermined relationship with the authorisation code.

12. The electronic device of claim 11, wherein the time value defines an extended time period or multiple time periods.

13. The electronic device of claim 12, wherein the code generation apparatus automatically removes time information received from the time measuring means to create the time value.

14. The electronic device of any one of claims 11 to 13, wherein the electronic device also includes identity information receiving means for receiving identity information identifying one or more users of the electronic device, wherein in use, the processing means receives the identity information and computes the validation code dependent on the identity information and the time value.

15. The electronic device of claim 14, wherein the electronic device computes a validation code from incomplete identity information, wherein the incomplete identity information defines a plurality of users.

16. The electronic device of claim 15, wherein the electronic device removes identity information from information received by the identity information receiving means to create the incomplete identity information.

17. The electronic device of either claim 15 or claim 16, wherein the electronic device determines from the incomplete identity information an identity code identifying each user defined by the incomplete identity information and computes a validation code for each identity code, wherein the electronic device is actuated if any one of the validation codes match the authorisation code or is a predetermined transformation of the authorisation code.

18. The electronic device of any one of claims 11 to 17, wherein the electronic device includes a predetermined device code readable by the processing means, wherein in use, the processing means computes the validation code dependent on the predetermined device code and the time value.

19. The electronic device of claim 18, wherein the electronic device includes a plurality of device codes, wherein the processing means computes a validation code for each device code and wherein the electronic device is actuated if any one of the validation codes match the authorisation code or is a predetermined transformation of the authorisation code.

20. The electronic device of either claim 18 or claim 19 when dependent on any one of claims 14 to 17, wherein the processing means computes the or each validation code dependent on the time value, identity information and device information.

21. The electronic device of any one of claims 11 to 20, wherein the authorisation code is generated by the code generation apparatus of any one of claims 1 to 10 and the processing means of the electronic device is programmed to compute a validation code that matches the authorisation code or has a predetermined relationship with the authorisation code when the time value is within a time period defined by the time information.

22. The electronic device of claim 21, wherein the authorisation code is generated by the code generation apparatus of either claim 6 or claim 7 and the processing means of the electronic device is programmed to compute a validation code that matches the authorisation code or has a predetermined relationship with the authorisation code when the identity information received by the electronic device defines at least one user defined by the identity information received by the code generation apparatus.

23. The electronic device of claim 21, wherein the authorisation code is generated by the code generation apparatus of either claim 8 or claim 9 and the processing means of the electronic device is programmed to compute a validation code that matches the authorisation code or has a predetermined relationship with the authorisation code when the device information of the electronic device is the, or one of the devices defined by the device information received by the code generation apparatus.

24. The electronic device of claim 12, wherein the authorisation code is generated by the code generation apparatus of claim 10 and the processing means of the electronic device is programmed to compute a validation code that matches the authorisation code or has a predetermined relationship with the authorisation code when the time value is within a time period defined by the time information and the identity information received by the electronic device defines at least one user defined by the identity information received by the code generation apparatus and the device information of the electronic device is the, or one of the devices defined by the device information received by the code generation apparatus.

25. An electronic system including at least one electronic device and at least one code generation apparatus for generating at least one authorisation code, the code generation apparatus including:
input means for facilitating the input of time information defining one or more time periods during which the electronic device may be actuated through use of the authorisation code;
first processing means to receive as an input the time information and generate an authorisation code dependent on the time information; and
transmission means to directly or indirectly communicate the authorisation code generated by the first processing means to one or more of the electronic devices;
wherein the or each electronic device includes:
receiving means for receiving an authorisation code generated by the code generation apparatus;
time measuring means for indicating a time value related to the time of receipt of an authorisation code by the receiving means;
second processing means to compute one or more validation codes dependent upon at least the time value and compare the one or more validation codes to the authorisation code; and
means to actuate the electronic device if the second processing means determines that at least one of the one or more validation codes match the authorisation code or has a predetermined relationship with the authorisation code.

26. The electronic system of claim 25, wherein the or each time period is further defined by a start time not being substantially the time of generation of the authorisation code.

27. The electronic system of claim 26, wherein the or each time period is further be defined by an end time.

28. The electronic system of any one of claims 25 to 27, wherein the second processing means is adapted to compute a validation code that matches the authorisation code or has the predetermined relationship with the authorisation code when the time value is within a time period defined by the time information and not otherwise.

29. The electronic system of any one of claims 25 to 28, wherein both the code generation apparatus and electronic device include identity information receiving means for receiving identity information identifying one or more users, wherein the first and second processing means receives the identity information and computes the authorisation code and validation code respectively dependent on the identity information and the time information and wherein the second processing means computes a validation code that matches the authorisation code or has the predetermined relationship with the authorisation code when the identity information received by the electronic device defines at least one user defined by the identity information received the code generation apparatus and not otherwise.

30. The electronic system of any one of claims 25 to 19, wherein the code generation apparatus includes device information receiving means for receiving device information defining one or more electronic devices and the or each electronic device includes at least one device code, wherein the first processing means computes the authorisation code dependent on the device information and the time information and the second processing means computes a validation code dependent for the or each device code and is adapted to compute a validation code that matches the authorisation code or has the predetermined relationship with the authorisation code when the device information defines the, or one of the device codes.

31. An electronic device as claimed in any one claims 11 to 24, wherein the means to actuate the electronic device includes means to lock or unlock a lock.

32. An electronic system as claimed in any one of claims 25 to 30, wherein the or each electronic device is an electronic lock.

33. A code generation apparatus substantially as herein described and with reference to FIGS. 1 and 2.

34. An electronic device substantially as herein described and with reference to FIGS. 3 to 5.

35. An electronic system substantially as herein described and with reference to the accompanying drawings.
